(19) United States
(12) Patent Application Publication
(10) Pub. No.: US 2018/0300772 A1
(43) Pub. Date: Oct. 18, 2018

(54) SYSTEM AND METHODS FOR PROMOTIONAL ADVERTISING AND COMMERCE IN HOSPITALITY RELATED BUSINESSES

(71) Applicant: James Howard Bushong, JR., Skillman, NJ (US)

(72) Inventor: James Howard Bushong, JR., Skillman, NJ (US)

(21) Appl. No.: 15/952,079

(22) Filed: Apr. 12, 2018

Related U.S. Application Data
(60) Provisional application No. 62/710,263, filed on Feb. 14, 2018.
(60) Provisional application No. 62/603,456, filed on May 30, 2017.
(60) Provisional application No. 62/602,183, filed on Apr. 13, 2017.
(60) Provisional application No. 62/602,765, filed on May 4, 2017.
(60) Provisional application No. 62/602,842, filed on May 8, 2017.
(60) Provisional application No. 62/602,841, filed on May 8, 2017.
(60) Provisional application No. 62/603,087, filed on May 17, 2017.

(51) Int. Cl. G06Q 30/02; G06Q 30/06; G06Q 50/12; G06Q 20/12; G06Q 20/38; G06K 7/14

(52) U.S. Cl. CPC G06Q 30/0277; G06Q 30/0603; G06K 7/1417; G06Q 20/12; G06Q 20/382; G06Q 50/12

(57) ABSTRACT

The present invention generally relates to systems and methods of advertising third-party products in hospitality-related businesses such as restaurants, hotels, and resorts; and facilitating commerce for the same. In particular, this invention relates to promotion and advertising in an eCommerce context based on direct user experience of items for which the eCommerce is intended.

### CROSS REFERENCE TO RELATED APPLICATIONS

This application claims the benefit of U.S. Provisional Patent Application No. 62/710,263 filed on Feb. 14, 2008, of U.S. Provisional Patent Application No. 62/603,456 filed on May 30, 2017, of U.S. Provisional Patent Application No. 62/602,183 filed on Apr. 13, 2017, of U.S. Provisional Patent Application No. 62/602,765 filed on May 4, 2017, of U.S. Provisional Patent Application No. 62/602,842 filed on May 8, 2017, of U.S. Provisional Patent Application No. 62/602,841 filed on May 8, 2017, and of U.S. Provisional Patent Application No. 62/603,087 filed on May 17, 2017 all of which are hereby incorporated by reference in their entirety.

### FIELD OF THE INVENTION

The present invention relates generally to promoting and advertising third-party products in hospitality-related businesses such as restaurants, hotels, and resorts. More specifically, this invention relates to facilitating commerce for such businesses in the eCommerce context based on direct user experience of items.

### BACKGROUND OF THE INVENTION

As used herein, any product that a customer of a hospitality-related business may encounter during their experience at the hospitality-related business that is not created or manufactured by that hospitality-related business is referred to as a “3^{rd}-party that hospitality-related business is referred to as a party product.” Any supplier of such a “3^{rd}-party product” is referred to herein as a “3^{rd}-party product supplier.” As used herein, the term “hospitality business” refers to any type of hospitality-related business. Singular and plural references may be used interchangeably throughout this specification.

eCommerce is quickly becoming the preferred and most prominent choice for buy and selling for virtually any good or service one can think of. It is growing to the point that the threat of losing direct-experience business in so-called “brick-and-mortar” stores may reduce total economic growth. This is because people can spend additional money on additional products and/or additional services when they visit brick-and-mortar locations and because brick-and-mortar stores employ people and create a variety of auxiliary jobs.

Restaurants are, of course, a popular form of enjoyment and sustenance in the United States and throughout the world. The enjoyment tends to focus on the quality and taste of the food served and ambiance of the restaurant. For quality of food, the quality and type of ingredients can frequently dictate the resulting taste of the food served. For ambiance, non-food related items such as the background music can frequently dictate customer satisfaction. Yet, there are either few or no methods of promotional advertising being utilized in restaurants for the particular supplier and type of food ingredients products used in the dishes being served, or for ambiance related products such as the musician/artist CD from which the background music is played. Since these products are part of a customers' enjoyment, the customer may very well be interested in purchasing these additional products if only there was a simple and reliable method to do so. Similar situations exist in other hospitality-related business including, but not limited to, hotels, resorts, cruise ships, fairs, and festivals wherein various 3^{rd}-party products greatly contribute to the comfort, enjoyment, and experience of the customers, but where few or no means are available for the customers to identify who the supplier is or where they can buy the same or similar products.

Therefore, there is a need in the art for a system and method for conveniently promoting, advertising, and facilitating the purchase and sale of such 3^{rd}-party products. These and other features and advantages of the present invention will be explained and will become obvious to one skilled in the art through the summary of the invention that follows.

### SUMMARY OF THE INVENTION

Accordingly, embodiments of the present invention are generally directed to a system comprising scannable, or otherwise digitally or electronically accessible instances of promotional advertising and methods related thereto. Embodiments of the present invention may include a code or visible advertisement linked to a 3^{rd}-party product available to be purchased by a customer via a digital platform or alternative purchasing means.

Some embodiment of the present invention offer simple and reliable methods for advertising and promoting sales of 3^{rd}-party products to customers of hospitality business. Other embodiments of the present invention may provide simple and reliable methods to track the 3^{rd}-party product sales generated from each hospitality business site. Yet other embodiments of the present invention may also enable 3^{rd}-party product suppliers to obtain promotional advertising that can increase their sales and the public's awareness of their products. An objective of the various embodiments of the present invention is to enable revenue sharing between the 3^{rd}-party product suppliers and the hospitality businesses on sales gained from the methods of promotional advertising of the present invention. Another objective of the present invention is to increase repeat and new business for hospitality-related businesses and to provide access to eCommerce portals linked to direct user experience of items for which eCommerce is intended.

Embodiments of the present disclosure are directed to a method of promotional advertising and increasing commerce of 3^{rd}-party products utilized in hospitality business, comprising: scannable ads for said 3^{rd}-party product, wherein said scannable ad may be placed on physical media located on said hospitality business property and may contain a unique internet link that is assigned to said 3^{rd}-party product for said hospitality business, wherein said scannable ad can be scanned with a scanning device, and wherein said scannable ad takes said scanning device to a website wherein said 3^{rd}-party product can be purchased, and wherein said purchase of said 3^{rd}-party product is traceable to said hospitality business from which said unique internet link was assigned, and wherein a record of said purchase of said 3^{rd}-party product is generated that can be provided to both the supplier of said 3^{rd}-party product and said hospitality business for which said unique internet link was assigned, and wherein said hospitality business and said 3^{rd}-party product supplier can negotiate a revenue sharing plan based on said purchase, and wherein while visiting said website, said unique internet link can generate an advertisement for said hospitality business for which said unique internet link was assigned, and wherein said advertisement for said hospitality business can include a promotional coupon for said hospitality business. Other embodiments of the present disclosure are directed to a method of digital promotional advertising and increasing commerce of a 3^{rd}-party product utilized in hospitality business, comprising: a hosted ad for said 3^{rd}-party product, wherein said hosted ad is placed on digital media platform located on said hospitality business property and contains a unique internet link that is assigned to said 3^{rd}-party product for said hospitality business, wherein said hosted ad can be clicked by a person, and wherein said click takes said person to a website wherein said 3^{rd}-party product can be purchased, and wherein said purchase of said 3^{rd}-party product is traceable to said hospitality business from which said unique internet link was assigned, and wherein a record of said purchase of said 3^{rd}-party product is generated that can be provided to both the supplier of said 3^{rd}-party product and said hospitality business for which said unique internet link was assigned, and wherein said hospitality business and said 3^{rd}-party product supplier can negotiate a revenue sharing plan based on said purchase, and wherein while visiting said website, said unique internet link can generate an advertisement for said hospitality business for which said unique internet link was assigned, and wherein said advertisement for said hospitality business can include a promotional coupon for said hospitality business. Yet other embodiments of the present disclosure are directed to a method of digital promotional advertising and increasing commerce of a 3^{rd}-party product utilized in hospitality business, comprising: providing hosted ad for said 3^{rd}-party product on any internet-enabled device, wherein said hosted ad contains a unique internet link that is assigned to said 3^{rd}-party product for said hospitality business, wherein said hosted ad can be clicked by a person, and wherein said click takes said person to a website wherein said 3^{rd}-party product can be purchased, and wherein said purchase of said 3^{rd}-party product is traceable to said hospitality business from which said unique internet link was assigned, and wherein a record of said purchase of said 3^{rd}-party product is generated that can be provided to both the supplier of said 3^{rd}-party product and said hospitality business for which said unique internet link was assigned, and wherein said hospitality business and said 3^{rd}-party product supplier can negotiate a revenue sharing plan based on said purchase, and wherein while visiting said website, said unique internet link can generate an advertisement for said hospitality business for which said unique internet link was assigned, and wherein said advertisement for said hospitality business can include a promotional coupon for said hospitality business. The methods disclosed herein can be implemented with various 3^{rd}-party products including, but not limited to, food ingredients, condiments, beverages, music CD's, dinnerware, cutlery, digital music songs, digital music CD's, music DVD's, digital music videos, concert tickets, window dressings, paintings, sheets, towels, beds, fixtures, and furniture.

According to an embodiment of the present disclosure, a system for promotional advertising and increasing commerce comprises: a 3rd-party product; an interactive element associated with said 3rd-party product capable of being activated via a computing device; a computing device configured to interact with said interactive element; and a virtual purchasing platform accessible via said computing device to purchase said 3rd-party product. According to one embodiment the interactive element may a scannable code capable of being scanned by said computing device and the computing device may be a mobile computing device. In another embodiment the interactive element may be a digital interactive element displayed on a screen of a computing device. According to several embodiments of the present disclosure, interaction via the computing device with the interactive element may cause the appearance of a user interface of a purchasing platform on a display means. In another embodiment of the present disclosure, among other payment methods, the purchasing platform is configured to accept payments via blockchain. In some embodiments, the purchasing platform is configured to have restricted access and may optionally be selected from the group comprising a website, a program, and an application. In other embodiments of the present disclosure, the purchasing platform further comprises an advertisement for a hospitality business associated with said interactive element. In the various embodiments, the purchasing platform may also be configured to identify a hospitality business from which a purchase of said 3rd-party product associated with said interactive element originated and to provide a record of a purchase of said 3rd-party product to either or both of a 3rd-party product supplier and a hospitality business from which said purchase of said 3rd-party product associated with said interactive element originated.

According to an embodiment of the present disclosure a method for promotional advertising and increasing commerce comprises: the step of providing an interactive element associated with a 3rd-party product, said interactive element selected from the group comprising a scannable code, a website link, an interactive visual program element, and a mobile device application button; and the step of interacting with said interactive element via a computing device to trigger the appearance of a virtual purchasing platform interface (which purchasing platform may have restricted access). According to one embodiment of the present disclosure, the step of interacting with said interactive element comprises the step of scanning a scannable code via said computing device. In other embodiments, the method further comprises the step of purchasing a 3rd-party product associated with the interactive element via the virtual purchasing platform. In yet other embodiments, thee method may further respectively comprise the step of identifying a hospitality business from which the purchase of said 3rd-party product associated with the interactive element originated, the step of generating a record of said purchase, and the step of providing a said record of said purchase of said 3rd-party product to either or both of a 3rd-party product supplier and a hospitality business from which said purchase of said 3rd-party product associated with said interactive element originated. Optionally, in an embodiment of the present invention, the method for promotional advertising and increasing commerce may further comprise the step of generating a unique advertisement for a hospitality business related to the interactive element associated with the 3rd-party product.

The foregoing summary of the present invention with some of the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a schematic illustration of an exemplary computing device in accordance with an embodiment of the present invention;

FIG. 2 is a schematic illustration of an exemplary network in accordance with an embodiment of the present invention;

FIG. 3A is a perspective view of an environment with items containing linked codes in accordance with an embodiment of the present invention;

FIG. 3B is a perspective view of an environment with print media containing linked codes in accordance with an embodiment of the present invention;

FIG. 4 is a perspective view of a digital media platform located on a hospitality-business property in accordance with an embodiment of the present invention;

FIG. 5 is a perspective view of a computing device screen displaying a visual element in accordance with an embodiment of the present invention; and

FIG. 6 depicts an exemplary method for promoting and facilitating sales of an item in accordance with an embodiment of the present invention.

### DETAILED DESCRIPTION

The present invention relates generally to promoting and advertising third-party products in hospitality-related businesses such as restaurants, hotels, and resorts. More specifically, this invention relates in-part to facilitating sales for such businesses in the eCommerce context based on direct user experience of items.

In the Summary above and in this Detailed Description, and the claims below, and in the accompanying drawings, reference is made to particular features of various embodiments of the invention. It is to be understood that the disclosure of embodiments of the invention in this specification includes all possible combinations of such particular features even if each such possible combination is not explicitly described. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

It should be noted that the features illustrated in the drawings are not necessarily drawn to scale, and that features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may”, through the use of any of the phrases: “in some embodiments,” “in some implementations,” “in some designs,” “in various embodiments,” “in various implementations,”, “in various designs,” “in an illustrative example,” or “for example”, or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features, or with all three of the three possible features.

In the present disclosure, the term “any” may be understood as designating any number of the respective elements, i.e. as designating one, at least one, at least two, each, or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure. The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

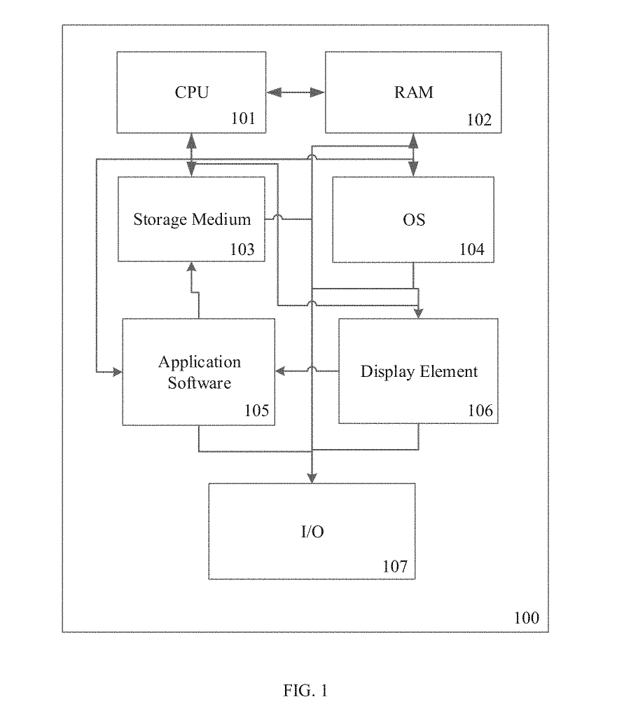

An illustrative representation of a computing device appropriate for use with embodiments of the system of the present disclosure is shown in FIG. 1. The computing device 100 can generally be comprised of a Central Processing Unit (CPU) 101, optional further processing units including a graphics processing unit (GPU), a Random Access Memory (RAM) 102, a mother board 103, or alternatively/additionally a storage medium (e.g., hard disk drive, solid state drive, flash memory, cloud storage), an operating system (OS) 104, one or more application software 105, a display element 106, and one or more input/output devices/means 107, including one or more communication interfaces (e.g. RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

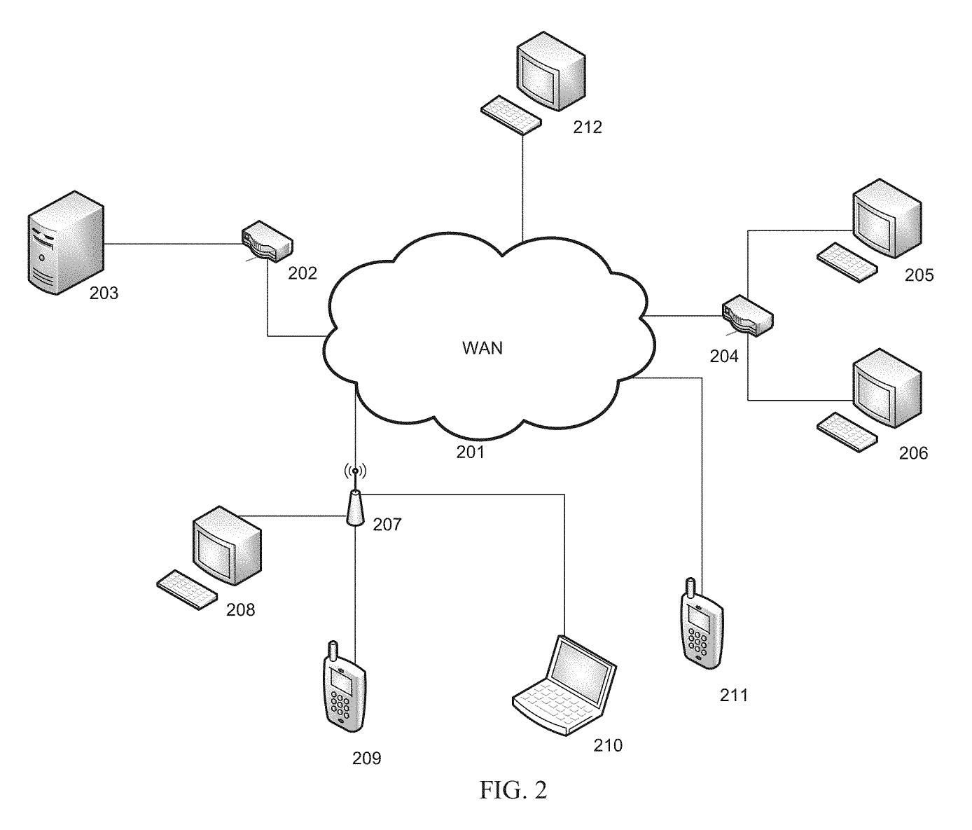

Various examples of such general-purpose multi-unit computer networks suitable for embodiments of the disclosure, their typical configuration and many standardized communication links are well known to one skilled in the art, as explained in more detail and illustrated by FIG. 2, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated may then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 2, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 1, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.” The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

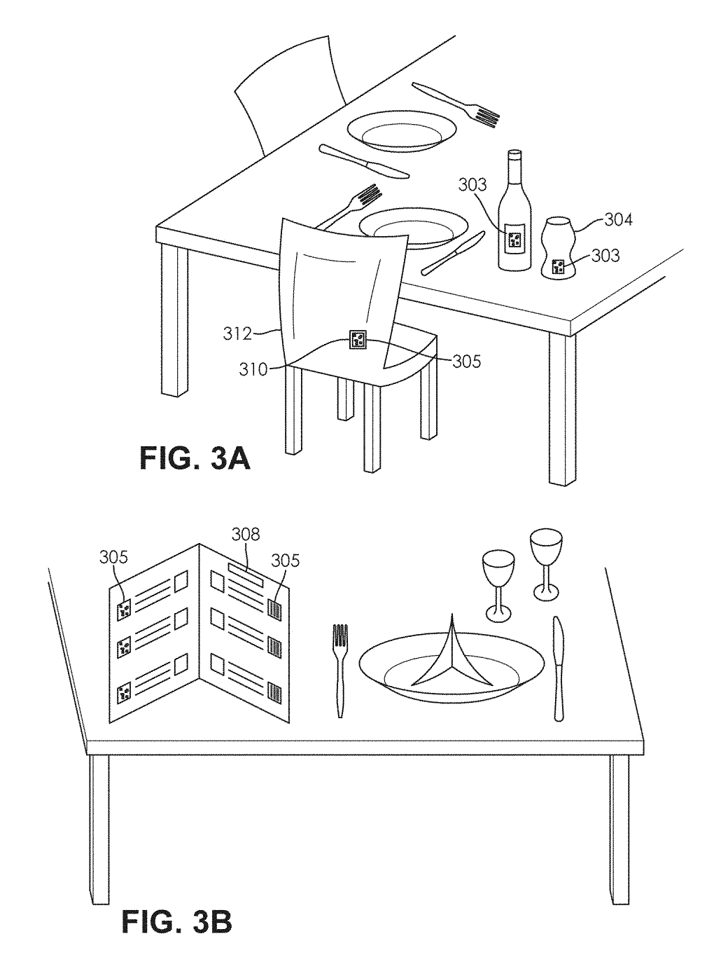

Embodiments of the present disclosure include scannable methods of promotional advertising and increasing commerce of products from 3^{rd}-party suppliers utilized in the hospitality business. As depicted in FIGS. 3A and 3B, in these embodiments, scannable codes, such as, for example, QR codes 303, are placed on 3^{rd}-party products or placed on printed media at convenient locations where the customers of the hospitality business can easily see them. In such embodiments, scannable codes for one or more of the 3^{rd}-party products that the hospitality business wishes to help promote can be printed on paper or marketing brochures of other material for customers to scan while at the hospitality business site or to take with them when they leave the site. For example, in accordance with some embodiments each hospitality business site can have a unique QR code 303 assigned for each 3^{rd}-party product offered, so that once scanned, the scan can be traced to the hospitality business where the scan originated. Generally in these embodiments, once the scannable code is scanned with a mobile phone or other scanning device by the customer, the customer is taken to a website wherein the 3^{rd}-party product can be purchased. While on the website wherein the 3^{rd}-party product can be purchased, the unique scannable code can generate an advertisement for the hospital business from which the unique code was scanned. In some of the embodiments of the present disclosure, advertisement for the hospitality business may or may not include a discount coupon or various levels of discount coupons depending on factors such as whether or not the hospitality business customer purchases any of said 3^{rd}-party product and how much money the customer spends on said 3^{rd}-party product and may alternatively use other promotional means to encourage repeat patronage of the hospitality business. According to certain embodiments of the present disclosure, if the hospitality business customer purchases the 3^{rd}-party product, a record is generated that can be provided to both the 3^{rd}-party product supplier and said hospitality business. The hospitality businesses and 3^{rd}-party product suppliers can negotiate a revenue sharing plan based on these sales records.

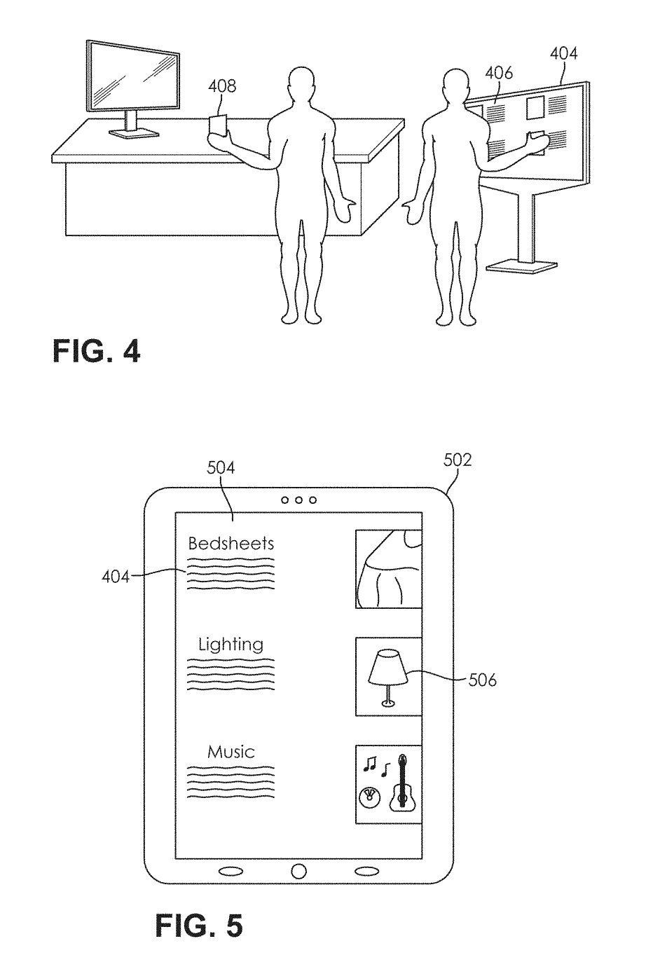

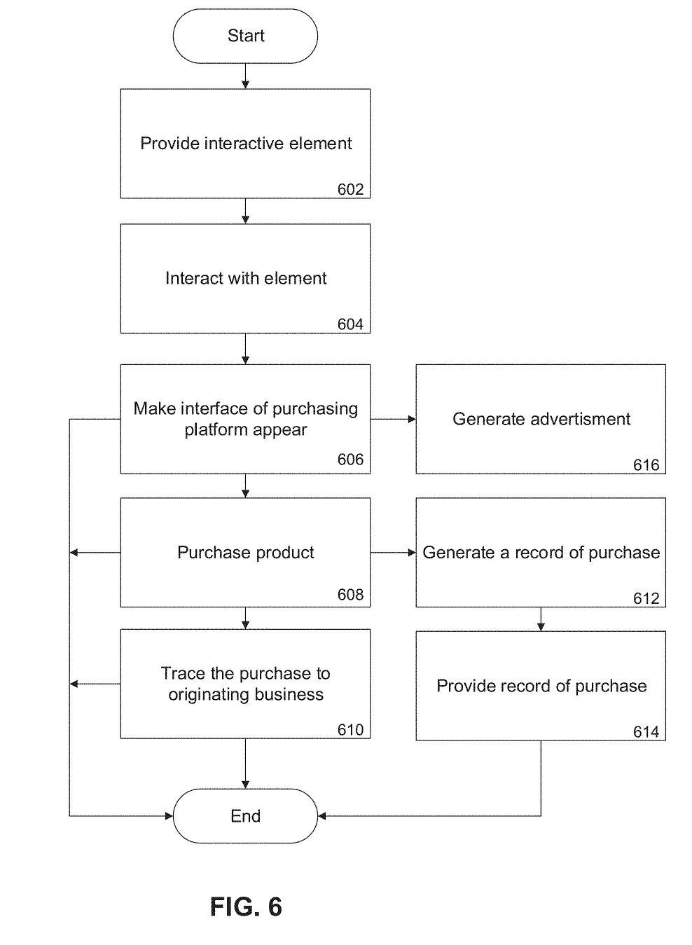

Other exemplary embodiments of the present disclosure, such as those depicted in FIGS. 4 and 5, include digital methods of promotional advertising and increasing commerce of products from 3^{rd}-party suppliers utilized in the hospitality business. In these embodiments, ads 406 for said products are hosted on any type of digital media platform 404 located on the hospitality business property. In accordance with some embodiments, Patrons of said hospitality business may elect to browse for these 3^{rd}-party products based on their experience at the hospitality business. These hosted ads 406 contain a unique internet (web) link that is assigned for each 3^{rd}-party product supplier for each hospitality business. Once these hosted ads 406 are selected by the patron, the uniquely assigned internet link takes the patron to a website wherein said 3^{rd}-party product can be purchased. In these embodiments, any purchase of said 3^{rd}-party product(s) may be traceable to said hospitality business from which said unique internet link was assigned. Said hospitality business and said 3^{rd}-party product suppliers can negotiate a revenue sharing plan based on these sales records. While on the website wherein the 3^{rd}-party product can be purchased, the unique internet link can generate advertisement for the hospitality business for which said unique internet link was assigned. Likewise, in some of these embodiments, advertisement for the hospitality business may or may not include a discount coupon or various levels of discount coupons depending on factors such as whether or not the hospitality business customer purchases any of said 3^{rd}-party product and how much money the customer spends on said 3^{rd}-party product and may alternatively use other promotional means to encourage repeat patronage of the hospitality business.

Other exemplary embodiments of digital promotional methods of the present disclosure, such as that depicted in FIG. 5, include hosting ads for 3^{rd}-party products that a hospitality business wishes to promote in a manner accessible by any internet-enabled device 502. Host ads 404 for said 3^{rd}-party products can for example be on either the hospitality business' website or another website. Examples of internet-enabled devices include computers, tablets, smart phones, and televisions. For example, according to some embodiments of the present disclosure, patrons of a hospitality business may elect to browse these 3^{rd}-party products based on their experience at the hospitality business. These hosted ads 404 may contain a unique internet (web) link that is created for each 3^{rd}-party product supplier for each hospitality business, so that any purchase of said 3^{rd}-party product suppliers' product(s) is traceable to the hospitality business from which said unique internet link was assigned. The hospitality business and 3^{rd}-party product suppliers can negotiate a revenue sharing plan based on said purchases. While on the website where the 3^{rd}-party product is offered for sale, the unique internet link can generate an advertisement for the hospitality business for which said unique internet link was assigned. Similarly, in these embodiments as well, the advertisements for the hospitality business may or may not include a discount coupon or various levels of discount coupons depending on factors such as whether or not the hospitality business customer purchases any of said 3^{rd}-party product and how much money the customer spends on said 3^{rd}-party product and may alternatively use other promotional means to encourage repeat patronage of the hospitality business.

In some embodiments, the 3^{rd}-party products available at each particular hospitality site can be aggregated as that particular hospitality site's hosted eCommerce portal. In these examples, the unique internet link takes the patron to that hospitality site's hosted eCommerce portal wherein any of that particular hospitality site's 3^{rd}-party products can be observed for purchase. It should be understood that an eCommerce portal may be any suitable digital representation of an interactive means of purchasing products via the internet, including, without limitation, a website, a program, or an application.

In certain embodiments of the present disclosure access to the eCommerce products available for each hospitality site can be limited. For example, the link to the eCommerce portal for the products available at each hospitality site may be such that it can only be accessed either inside or in proximity to the hospitality business site. In another embodiment, the link to or an application for the eCommerce portal for the products available at each hospitality site may be such that it can only be accessed by using the internet network of the hospitality site. This limited access can help ensure that the eCommerce is tied directly to user experience at the hospitality site.

Various embodiments of the present invention may include software to manage the promotional advertising methods, or the sales transactions of any commerce created therefrom, or both the promotional advertising methods and the sales transactions of any commerce created therefrom, or any other software to facilitate any part of the methods of the present invention. The present invention may include the service of web hosting 3^{rd}-party product suppliers' promotional ads 404 for one or more hospitality business, or any other form of internet (web) hosting, for use in the methods of the present invention. The present invention may include the service of preparing ads 404 for one or more 3^{rd}-party product suppliers, for use in the methods of the present invention. The present invention may include the use of an application to facilitate any or all parts of the methods of the present invention, such as a smart-phone application. The present invention may include any type of eCommerce platform that utilizes any of the methods of the present invention. The present invention can utilize any means of ad hosting, including printed media, stickers, tags, digital media, computers, tablets, smart phones, televisions, and any other type of physical and digital media. Patron activation of the methods of the present invention can be with scanning, clicking, or any other form of activating said hosted ad that takes said patron to a web site wherein said 3^{rd}-party product can be purchased.

The methods of promotional advertising and increasing commerce of the present invention are thus seen to be beneficial for both the 3^{rd}-party products and the hospitality business, and provide an increased stream of revenue for both the 3^{rd}-party products and the hospitality business, and increase public awareness for the 3^{rd}-party products and 3^{rd}-party product suppliers, and encouraging repeat and new business to the hospitality business. The invention is thus seen as a win-win-win scenario for both the 3^{rd}-party product suppliers and the hospitality businesses, and for patrons at hospitality business so that they can easily find and purchase products that provided enjoyment during their experience at the hospitality business. Patrons telling their friends about where they purchased their products can help lead to new business to the hospitality site.

The methods of the present invention may be extended to other industries to achieve similar benefits and commerce.

In accordance with the various embodiments described herein, the methods of the present disclosure may generally comprise several steps. One step is the provision 602 of an interactive element such as a unique scannable code 305 or a link on a web site or application associated with a 3^{rd}-party product. Another step is the activation 604 or interaction with the interactive element by a user or customer. Another step is the loading and appearance 606 of a virtual interface of a virtual purchasing platform such as a website page or application interface where the associated 3^{rd}-party product is displayed for purchase. An optional step is the purchasing 608 of a 3^{rd}-party product via a virtual interface. Another optional step may be tracing 610 the purchase of a 3^{rd}-party product to the hospitality business from whose interactive element the purchase originated. Other optional steps may be generating 612 a record of the purchase and providing 614 the record to either or both of the 3^{rd}-party supplier of the 3^{rd}-party product and the hospitality business from whose interactive element the purchase originated. Yet another optional step in embodiments of the present invention may be the generating a unique advertisement 616 for the hospitality business on the website or application interface where the associated 3^{rd}-party product is displayed for purchase.

### EXEMPLARY EMBODIMENTS

Although specific embodiments of the present invention will now be described, it should be understood that such embodiments are by way of example only and merely illustrative of but a small number of the many possible specific embodiments which can represent applications of the principles of the present invention. Changes and modifications by persons skilled in the art to which the present invention pertains are within the spirit, scope and contemplation of the present invention as further defined in the appended claims. Singular and plural references are interchangeable and may represent one or more of any particular reference. All references cited herein are incorporated by reference as if each had been individually incorporated.

Turning now to FIGS. 3A, 3B and 4, several embodiments of the present disclosure are illustrated. One embodiment of the present disclosure incorporates the use of scannable QR type codes 303 for purchasing the CD of the music playing in a restaurant. The scannable QR code 303 can, for example, be placed on postcard style marketing literature 408, or any type of printed marketing literature, and placed, for example, at the hostess/waiting area, at the bar, or on the tables of a restaurant. In accordance with some embodiments, restaurant patrons can, for example, take the postcard with them after their dining experience and scan the QR code 303 at home or another location, or they may for example scan the QR code 303 while waiting for their food to be served, or they may, for example, scan the QR code 303 while waiting to be seated. In accordance with certain embodiments of the present disclosure, patrons can elect to purchase the CD or for example the digital version of the CD at the website to which the QR scan takes them. Both the creator of the music CD and the restaurants may be alerted as to the sales generated from each individual restaurant via the unique QR code 303 assigned to each restaurant. Revenue sharing from sales of the CD can be pre-negotiated between the creator of the music CD and the restaurant. A restaurant ad (triggered by the restaurant's unique QR code) can pop up on the website wherein the music CD is offered for sale. Said restaurant ad can remind the patrons of the enjoyable experience at the restaurant and lead to additional repeat business to the restaurant, and/or said restaurant ad can include for example a promotional coupon for use on a subsequent visit to the restaurant as another means of encouraging repeat business to the restaurant.

In another embodiment, shown in FIG. 3A, a food ingredient or condiment utilized in the preparation of the restaurant's food can use a uniquely assigned scannable QR code 303 on a container of the condiment or on printed media for purchasing said food ingredient or condiment. For example, a sticker containing the uniquely assigned QR code 303 can be placed on a jar 304 of a specialty condiment. The methods of the present invention to create the win-win-win situation for the 3^{rd}-party suppliers of the food ingredient or condiment, the restaurant, and the restaurant patrons are similar to the music CD printed media embodiment.

In another embodiment, the sheets used on a bed in a hotel can use the same uniquely assigned scannable code on printed media and commerce method for purchasing said sheets. For example, a tag can be sewn into said sheets that contain the uniquely assigned scannable code 305. In another embodiment of the present disclosure, shown in FIG. 3B, printed media such as a paper, a menu, or an advertising brochure is placed in the hotel room or restaurant, with said uniquely assigned scannable codes 305 for the ingredients, sheets or any other product the hotel or restaurant wishes to promote such as the bed and the drapes in the room for example. In another example, a sticker 310 or stamp with the uniquely assigned scannable code 305 of the present invention can be placed on a piece of furniture, such as a chair 312, in a hotel room or restaurant to utilize the systems and methods of the present invention.

Another exemplary embodiment of the present invention, such as the one depicted in FIG. 4, involves hosting an ad 406 on digital media platforms 404 located on the restaurant's property, for purchasing various food ingredients such as specialty condiments or organic produce utilized in the food at a restaurant. For example, ads 406 for various food ingredients can be placed on the restaurant's digital menus located at the tables and/or the bar, and the ads 404 may contain unique internet links (for each food ingredient) that are traceable to the restaurant. In accordance with this type of embodiment, patrons of said restaurant who enjoyed the food during their dining experience can click the unique internet links (before, during, or after their dining experience) and be taken to a corresponding website where the food ingredient(s) can be purchased. If any food ingredient is purchased by way of the unique internet link assigned to said restaurant for said food ingredient, both the food ingredient supplier and restaurant can be alerted of said purchases. Revenue sharing from sales of the food ingredient can be pre-negotiated between the supplier of the food ingredient and the restaurant. While a customer is browsing the website to purchase said food ingredient, a promotional ad (such as a discount coupon) for the restaurant from which said unique internet link was assigned can pop up on said website. Said promotional ad for said restaurant can remind the customers of the enjoyable experience at the restaurant and lead to additional repeat business to the restaurant.

In another embodiment, the hosted ad 406 placed on digital media platforms 404 located on the restaurant's property can be for the CD or digital versions of the music playing in the background. A similarly uniquely assigned internet link and previously described commerce methods of the present disclosure for food related items using digital media platforms results in the same type of benefits for the musician's CD. In this embodiment, the methods of the present invention to create the win-win-win situation for the musicians, the restaurant, and the restaurant patrons are analogous to those of the food ingredient digital media embodiment.

In another embodiment, the host ad on digital media platform is made available on the television in a hotel room. An analogous uniquely assigned internet link and the commerce methods of the present disclosure described earlier for food related items using digital media platforms results in the same type of benefits for any type of 3^{rd}-party product that the hotel wishes to promote. The methods of this embodiment to create the win-win-win situation for the 3^{rd}-party product suppliers, the hotel, and the hotel patrons are analogous to those of the food ingredient digital media embodiment.

In another embodiment, such as the one shown in FIG. 5, an application operable on a computing device 502, such as a tablet or smart-phone, provides access to the hosted ads for any of the methods of the present invention. For example, a mobile computing device application 504 can geo-track the location of patrons of any type of hospitality business. In another exemplary embodiment, the patron simply inputs the hospitality business name and/or address into a smart phone application 504. For any smart phone or mobile computing device application example, the application can for example bring up a list of featured 3^{rd}-party products 506 that utilize the methods of the present invention for the particular hospitality business where the patron is located.

In any embodiment, the 3^{rd}-party products available at each particular hospitality site can be aggregated at that particular hospitality site's hosted eCommerce portal. In these examples, the unique internet link or application interface takes the patron to that hospitality site's hosted eCommerce portal wherein any of that particular hospitality site's 3^{rd}-party products can be viewed for purchase. In any embodiment, payment for 3^{rd}-party products may be made via blockchain as well as other payment means such as credit cards. In any embodiment, access to the eCommerce portal can be limited for the particular products listed for sale at each hospitality site. For example, in one embodiment, the link to or the application for the eCommerce portal for the products available at each hospitality site can only be accessed by using the internet network of the hospitality site. This limited access can help ensure that the eCommerce is tied directly to user experience at the hospitality site.

Examples of 3^{rd}-party products that can utilize the methods of promotional advertising and increasing commerce of the present invention include but are not limited to food ingredients, condiments, beverages, music CD's, dinnerware, cutlery, digital music songs, digital music CD's, music DVD's, digital music videos, concert tickets, clothing worn by any of the hospitality staff, window dressings, paintings, sheets, towels, beds, fixtures, and furniture.

Any of the embodiments of the present invention can utilize one or more concepts or combinations of any singular embodiment.

It should be noted that the features illustrated in the drawings are not necessarily drawn to scale, and features of one embodiment may be employed with other embodiments as the skilled artisan would recognize, even if not explicitly stated herein. Descriptions of well-known components may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for promotional advertising and increasing commerce comprising:
a 3^{rd}-party product;
an interactive element associated with said 3^{rd}-party product capable of being activated via a computing device;
a computing device configured to interact with said interactive element; and
a virtual purchasing platform accessible via said computing device to purchase said 3^{rd}-party product.

2. The system of claim 1, wherein said interactive element is a scannable code capable of being scanned by said computing device.

3. The system of claim 1, wherein said computing device is a mobile computing device.

4. The system of claim 1, wherein said interactive element is a digital interactive element displayed on a screen of a computing device.

5. The system of claim 1, wherein interaction via said computing device with said interactive element causes the appearance of a user interface of said purchasing platform on a display means.

6. The system of claim 1, wherein said purchasing platform is configured to accept payments via blockchain.

7. The system of claim 1, wherein said purchasing platform is configured to have restricted access.

8. The system of claim 1, wherein said purchasing platform is selected from the group comprising a website, a program, and an application.

9. The system of claim 8, wherein said purchasing platform further comprises an advertisement for a hospitality business associated with said interactive element.

10. The system of claim 8, wherein said purchasing platform is configured to identify a hospitality business from which a purchase of said 3^{rd}-party product associated with said interactive element originated.

11. The system of claim 8, wherein said purchasing platform is configured to provide a record of a purchase of said 3^{rd}-party product to either or both of a 3^{rd}-party product supplier and a hospitality business from which said purchase of said 3^{rd}-party product associated with said interactive element originated.

12. A method for promotional advertising and increasing commerce comprising:
the step of providing an interactive element associated with a 3^{rd}-party product, said interactive element selected from the group comprising a scannable code, a website link, an interactive visual program element, and a mobile device application button; and
the step of interacting with said interactive element via a computing device to trigger the appearance of a virtual purchasing platform interface.

13. The method of claim 12 wherein the step of interacting with said interactive element comprises the step of scanning a scannable code via said computing device.

14. The method of claim 12 further comprising the step of purchasing a 3^{rd}-party product associated with said interactive element via said virtual purchasing platform.

15. The method of claim 14 further comprising the step of identifying a hospitality business from which said purchase of said 3^{rd}-party product associated with said interactive element originated.

16. The method of claim 14 further comprising the step of generating a record of said purchase.

17. The method of claim 16 further comprising the step of providing a said record of said purchase of said 3^{rd}-party product to either or both of a 3^{rd}-party product supplier and a hospitality business from which said purchase of said 3^{rd}-party product associated with said interactive element originated.

18. The method of claim 12, further comprising the step of generating a unique advertisement for a hospitality business related to said interactive element associated with said 3^{rd}-party product.

19. The method of claim 12 wherein the purchasing platform interface has restricted access.

20. A method of digital promotional advertising and increasing commerce of a 3^{rd}-party product utilized in hospitality business comprising:
providing an interactive element associated with said 3^{rd}-party product;
placing said interactive element on a medium located on said hospitality business property;
interacting with said interactive element via a computing device to trigger the appearance of a purchasing platform where said 3^{rd}-party product can be purchased and which platform can trace said purchase of said 3^{rd}-party product to said hospitality business;
generating a record of said purchase of said 3^{rd}-party product that can be provided to both a supplier of said 3^{rd}-party product and said hospitality business;
sharing revenue from said purchase between said hospitality business and said 3^{rd}-party product supplier; and
restricting access to said purchasing platform.
